(19) United States
(12) Patent Application Publication
(10) Pub. No.: US 2017/0278239 A1
(43) Pub. Date: Sep. 28, 2017

(54) DYNAMIC ANALYSIS APPARATUS AND DYNAMIC ANALYSIS SYSTEM

(71) Applicant: Konica Minolta, Inc., Tokyo (JP)

(72) Inventors: Koichi FUJIWARA, Osaka-shi (JP); Hitoshi FUTAMURA, Tokyo (JP); Akinori TSUNOMORI, Tokyo (JP); Sho NOJI, Tokyo (JP)

(21) Appl. No.: 15/455,335

(22) Filed: Mar. 10, 2017

(30) Foreign Application Priority Data
Mar. 24, 2016 (JP) 2016-059343

(51) Int. Cl. G06T 7/00

(52) U.S. Cl. CPC G06T 7/0012; G06T 2207/10116

(57) ABSTRACT

A dynamic analysis apparatus, including a processor which selects one or more frame images from a plurality of frame images of a dynamic image that is obtained by performing radiation imaging of a subject including a target site in a living body, recognizes a shape of a predetermined body part from each of the selected one or more frame images and calculates an evaluation value of the recognized shape of the body part.

### CROSS-REFERENCE TO RELATED APPLICATIONS

The entire disclosure of Japanese Patent Application No. 2016-059343 filed on Mar. 24, 2016 including description, claims, drawings and abstract are incorporated herein by reference in its entirety.

### BACKGROUND OF THE INVENTION

1. Field of the Invention

The present invention relates to a dynamic analysis apparatus and a dynamic analysis system.

2. Description of Related Art

In recent years, by applying digital techniques, it has been possible to relatively easily obtain images (referred to as dynamic images) capturing movements of affected areas by radiation imaging. For example, it is possible to obtain dynamic images capturing body parts including sites (referred to as target sites) which are targets of examination and diagnosis by the imaging using semiconductor image sensors such as FPDs (flat panel detectors).

Since the diagnosis based on dynamic images uses a large amount of information, there are large burdens on doctors at diagnosis and the diagnosis results may be different according to the proficiencies of doctors.

Thus, for example, Patent document 1 (Japanese Patent Application Laid Open Publication No. 2016-2251) describes a technique of calculating an evaluation value regarding a deformation degree of a movingly deforming part in a body part which is included in the dynamic image and providing the calculated evaluation value for diagnosis.

However, though the Patent document 1 evaluates the deformation of the body part, that is, the degree of change in shape on the basis of the dynamic image, the Patent document 1 does not evaluate the shape itself of the body part on the basis of the dynamic image to provide the evaluation value for diagnosis.

### SUMMARY OF THE INVENTION

An object of the present invention is to enable efficient and stable diagnosis based on the shape of body part included in a dynamic image.

In order to solve the above problems, according to one aspect of the present invention, there is provided a dynamic analysis apparatus, including a processor which selects one or more frame images from a plurality of frame images of a dynamic image that is obtained by performing radiation imaging of a subject including a target site in a living body, recognizes a shape of a predetermined body part from each of the selected one or more frame images and calculates an evaluation value of the recognized shape of the body part.

According to another aspect of the present invention, there is provided a dynamic analysis system, including: a radiation imaging apparatus which obtains a plurality of frame images of a dynamic image by performing radiation imaging of a subject including a target site in a living body; and a diagnostic console which includes a processor that selects one or more frame images from the plurality of frame images of the dynamic image obtained by the radiation imaging apparatus, recognizes a shape of a predetermined body part from each of the selected one or more frame images and calculates an evaluation value of the recognized shape of the body part.

### BRIEF DESCRIPTION OF THE DRAWINGS

The above and other objects, advantages and features of the present invention will become more fully understood from the detailed description given hereinafter and the appended drawings which are given byway of illustration only, and thus are not intended as a definition of the limits of the present invention, and wherein:

FIG. 1 is a view showing the entire configuration of a dynamic analysis system in an embodiment of the present invention;

FIG. 2 is a flowchart showing imaging control processing executed by a control section of an imaging console in FIG. 1;

FIG. 3 is a flowchart showing shape evaluation processing executed by a control section of a diagnostic console in FIG. 1;

FIG. 4 is a view showing the change in lung field during breathing movement;

FIG. 5 is a view showing a display example for selecting a target frame image by user's operation;

FIG. 6 is a view showing a display example for selecting a target frame image by user's operation;

FIG. 7A is a view showing an example of diaphragm of a healthy person;

FIG. 7B is a view showing an example of diaphragm of a patient having a disease in a lung; and

FIG. 8 is a view for explaining a calculation method of an index value indicating linearity as a shape evaluation value of diaphragm.

### DETAILED DESCRIPTION OF THE PREFERRED EMBODIMENT

Hereinafter, an embodiment of the present invention will be described in detail with reference to the drawings. However, the scope of the present invention is not limited to the illustrated examples.

### [Configuration of Dynamic Analysis System 100]

First, the configuration will be described.

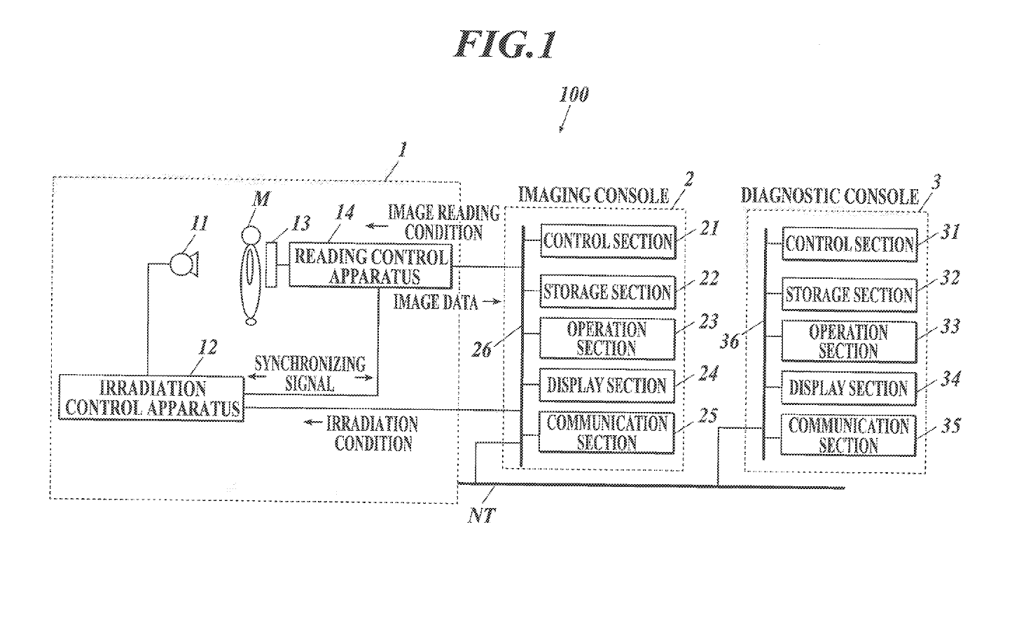

FIG. 1 shows the entire configuration of a dynamic analysis system 100 in the embodiment.

As shown in FIG. 1, the dynamic analysis system 100 is configured by connecting an imaging apparatus 1 to an imaging console 2 by a communication cable or the like, and connecting the imaging console 2 to a diagnostic console 3 via a communication network NT such as a LAN (Local Area Network). The apparatuses forming the dynamic analysis system 100 are compliant with the DICOM (Digital Image and Communications in Medicine) standard, and the apparatuses communicate with each other according to the DICOM.

### [Configuration of Imaging Apparatus 1]

The imaging apparatus 1 is, for example, a radiation imaging apparatus which performs imaging of a dynamic state of a living body such as the state change of inflation and deflation of a lung according to breathing movement and heart beat. The dynamic imaging means obtaining a plurality of images by repeatedly emitting a pulsed radiation such as X-ray to a subject at a predetermined time interval (pulse irradiation) or continuously emitting the radiation (continuous irradiation) at a low dose rate without interruption. A series of images obtained by the dynamic imaging is referred to as a dynamic image. Each of the plurality of images forming the dynamic image is referred to as a frame image. The following embodiment will be described by taking, as an example, a case where the dynamic imaging is performed by pulse irradiation. The following embodiment will be described by taking, as an example, a case where the target site which is the target of diagnosis is a lung field and the shape of diaphragm is evaluated for diagnosing the ventilation function of the lung field according to breathing. However, the present invention is not limited to the examples.

A radiation source 11 is located at a position facing a radiation detection section 13 through a subject M, and emits radiation (X ray) to the subject M in accordance with control of an irradiation control apparatus 12.

The irradiation control apparatus 12 is connected to the imaging console 2, and performs radiation imaging by controlling the radiation source 11 on the basis of an irradiation condition which was input from the imaging console 2. The irradiation condition input from the imaging console 2 is a pulse rate, a pulse width, a pulse interval, the number of imaging frames per imaging, a value of X-ray tube current, a value of X-ray tube voltage and a type of applied filter, for example. The pulse rate is the number of irradiation per second and consistent with an after-mentioned frame rate. The pulse width is an irradiation time required for one irradiation. The pulse interval is a time from start of one irradiation to start of next irradiation, and consistent with an after-mentioned frame interval.

The radiation detection section 13 is configured by including a semiconductor image sensor such as an FPD. The FPD has a glass substrate, for example, and a plurality of detection elements (pixels) is arranged in matrix at a predetermined position on the substrate to detect, according to the intensity, at least radiation which was emitted from the radiation source 11 and has transmitted through the subject M, and convert the detected radiation into electric signals to be accumulated. Each pixel is formed of a switching section such as a TFT (Thin Film Transistor), for example. The FPD may be an indirect conversion type which converts X ray into an electrical signal by photoelectric conversion element via a scintillator, or may be a direct conversion type which directly converts X ray into an electrical signal. In the embodiment, the pixel value (density value) of image data generated in the radiation detection section 13 is larger as the transmission amount of radiation is larger.

The radiation detection section 13 is provided to face the radiation source 11 via the subject M.

The reading control apparatus 14 is connected to the imaging console 2. The reading control apparatus 14 controls the switching sections of respective pixels in the radiation detection section 13 on the basis of an image reading condition input from the imaging console 2, switches the reading of electric signals accumulated in the pixels, and reads out the electric signals accumulated in the radiation detection section 13 to obtain image data. The image data is a frame image. The reading control apparatus 14 outputs the obtained frame image to the imaging console 2. The image reading condition includes a frame rate, frame interval, a pixel size, an image size (matrix size) and such like. The frame rate is the number of frame images obtained per second and consistent with the pulse rate. The frame interval is a time from start of obtaining one frame image to start of obtaining the next frame image, and consistent with the pulse interval.

Here, the irradiation control apparatus 12 and the reading control apparatus 14 are connected to each other, and transmit synchronizing signals to each other to synchronize the irradiation operation with the image reading operation.

### [Configuration of Imaging Console 2]

The imaging console 2 outputs the irradiation condition and the image reading condition to the imaging apparatus 1, controls the radiation imaging and reading operation of radiation images by the imaging apparatus 1, and displays the dynamic image obtained by the imaging apparatus 1 for an operator, who performs the imaging, such as an imaging operator to confirm positioning and whether the image is appropriate for diagnosis.

As shown in FIG. 1, the imaging console 2 is configured by including a control section 21, a storage section 22, an operation section 23, a display section 24 and a communication section 25, which are connected to each other via a bus 26.

The control section 21 is configured by including a CPU (Central Processing Unit), a RAM (Random Access Memory) and such like. According to the operation of operation section 23, the CPU of the control section 21 reads out system programs and various processing programs stored in the storage section 22 to load the programs into the RAM, executes various types of processing including after-mentioned imaging control processing in accordance with the loaded program, and integrally controls the operations of sections in the imaging console 2, the irradiation operation and the reading operation of the imaging apparatus 1.

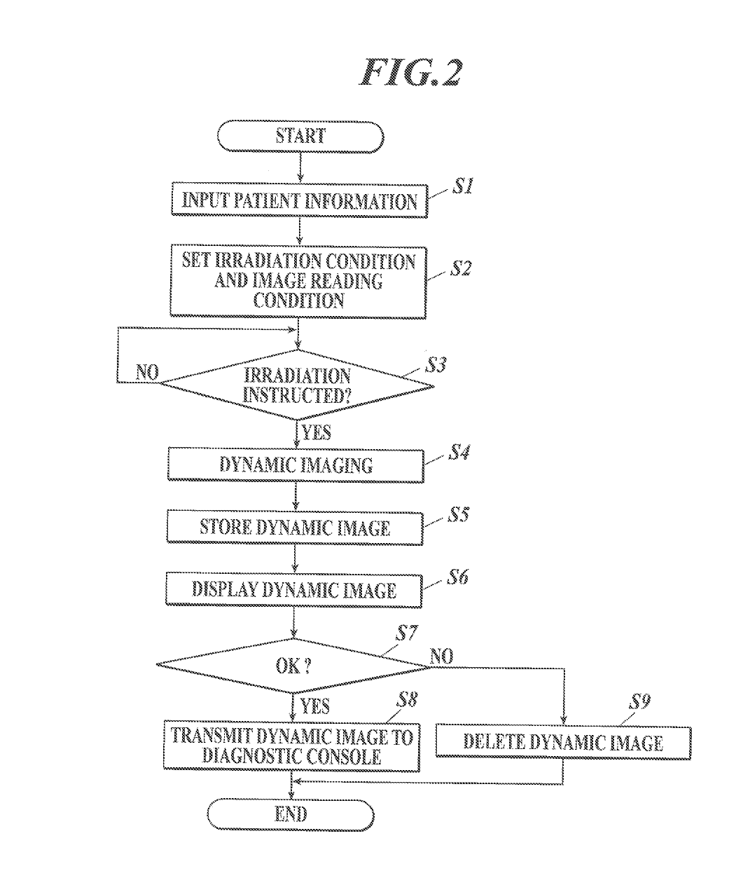

The storage section 22 is configured by including a non-volatile semiconductor memory and a hard disk. The storage section 22 stores various programs executed by the control section 21, parameters necessary for executing processing by the programs, and data of processing results. For example, the storage section 22 stores a program for executing the imaging control processing shown in FIG. 2. The storage section 22 stores the irradiation condition and the image reading condition so as to be associated with the imaging site. The various programs are stored in a form of readable program code, and the control section 21 executes the operation according to the program code as needed.

The operation section 23 is configured by including a keyboard including cursor keys, numeric keys and various function keys and a pointing device such as a mouse. The operation section 23 outputs, to the control section 21, an instruction signal which was input by a key operation to the keyboard or a mouse operation. The operation section 23 may include a touch panel on the display screen of display section 24. In this case, the operation section 23 outputs the input instruction signal to the control section 21 via the touch panel.

The display section 24 is configured by a monitor such as an LCD (Liquid Crystal Display) and a CRT (Cathode Ray Tube), and displays instructions input from the operation section 23, data and such like in accordance with an instruction of a display signal input from the control section 21.

The communication section 25 includes a LAN adapter, a modem, a TA (Terminal Adapter) and such like, and controls the data transmission and reception with the apparatuses connected to the communication network NT.

### [Configuration of Diagnostic Console 3]

The diagnostic console 3 is a dynamic analysis apparatus for obtaining the dynamic image from the imaging console 2 and displaying the obtained dynamic image, shape evaluation result of a body part included in the dynamic image and such like to support diagnosis by a doctor.

As shown in FIG. 1, the diagnostic console 3 is configured by including a control section 31, a storage section 32, an operation section 33, a display section 34 and a communication section 35, which are connected to each other via a bus 36.

The control section 31 is configured by including a CPU, a RAM and such like. According to the operation of the operation section 33, the CPU of the control section 31 reads out system programs stored in the storage section 32 and various processing programs to load them into the RAM, executes the various types of processing including after-mentioned shape evaluation processing in accordance with the loaded program, and integrally controls operations of the sections in the diagnostic console 3.

The storage section 32 is configured by including a non-volatile semiconductor memory, a hard disk and such like. The storage section 32 stores various programs including a program for executing the shape evaluation processing by the control section 31, parameters necessary for executing processing by the programs and data of processing results. The various programs are stored in a form of readable program code, and the control section 31 executes the operation according to the program code as needed.

The operation section 33 is configured by including a keyboard including cursor keys, numeric keys and various function keys and a pointing device such as a mouse, and outputs, to the control section 31, an instruction signal input by a key operation to the keyboard and a mouse operation. The operation section 33 may include a touch panel on the display screen of the display section 34. In this case, the operation section 33 outputs, to the control section 31, an instruction signal which was input via the touch panel.

The display section 34 is configured by including a monitor such as an LCD and a CRT, and performs various displays in accordance with the instruction of display signal input from the control section 31.

The communication section 35 includes a LAN adapter, a modem, a TA and such like, and controls data transmission and reception with the apparatuses connected to the communication network NT.

### [Operation of Dynamic Analysis System 100]

Next, the operation of the dynamic analysis system 100 will be described.

### (Operations of Imaging Apparatus 1 and Imaging Console 2)

First, imaging operations by the imaging apparatus 1 and the imaging console 2 will be described.

FIG. 2 shows imaging control processing executed by the control section 21 in the imaging console 2. The imaging control processing is executed in cooperation between the control section 21 and the program stored in the storage section 22.

First, the operator operates the operation section 23 in the imaging console 2, and inputs patient information (patient name, height, weight, age, sex and such like) of the subject being examined (subject M) and imaging site (here, chest) (step S1).

Next, the irradiation condition is read out from the storage section 22 and set in the irradiation control apparatus 12, and the image reading condition is read out from the storage section 22 and set in the reading control apparatus 14 (step S2).

An instruction of irradiation by the operation of operation section 23 is waited (step S3). The operator locates the subject M between the radiation source 11 and the radiation detection section 13, and performs positioning. Since the imaging is performed while the subject M is breathing in the embodiment, the operator instructs the subject being examined (subject M) to be at ease to lead the subject M into quiet breathing. Or the operator may perform induction of deep breathing by instructing “Breath in and breath out” or the like. When the preparation for imaging is completed, the operator operates the operation section 23 to input an irradiation instruction.

When the irradiation instruction is input from the operation section 23 (step S3: YES), the imaging start instruction is output to the irradiation control apparatus 12 and the reading control apparatus 14, and the dynamic imaging is started (step S4). That is, radiation is emitted by the radiation source 11 at the pulse interval set in the irradiation control apparatus 12, and frame images are obtained by the radiation detection section 13.

When the imaging is finished for a predetermined number of frames, the control section 21 outputs an instruction to end the imaging to the irradiation control apparatus 12 and the reading control apparatus 14, and the imaging operation is stopped. The imaging is performed to obtain the number of frame images which can image at least one breathing cycle.

The frame images obtained by the imaging are input to the imaging console 2 in order, stored in the storage section 22 so as to be associated with respective numbers (frame numbers) indicating the imaging order (step S5), and displayed on the display section 24 (step S6). The operator confirms positioning and such like by the displayed dynamic image, and determines whether an image appropriate for diagnosis was acquired by the imaging (imaging was successful) or imaging needs to be performed again (imaging failed). The operator operates the operation section 23 and inputs the determination result.

If the determination result indicating that the imaging was successful is input by a predetermined operation of the operation section 23 (step S7: YES), each of a series of frame images obtained by the dynamic imaging is accompanied with information such as an identification ID for identifying the dynamic image, the patient information, the imaging site, the irradiation condition, the image reading condition and the number (frame number) indicating the imaging order (for example, the information is written into a header region of image data in the DICOM format), and transmitted to the diagnostic console 3 via the communication section 25 (step S8). Then, the processing ends. On the other hand, if the determination result indicating that the imaging failed is input by a predetermined operation of operation section 23 (step S7: NO), the series of frame images stored in the storage section 22 is deleted (step S9), and the processing ends. In this case, the imaging needs to be performed again.

### (Operation of Diagnostic Console 3)

Next, the operation of diagnostic console 3 will be described.

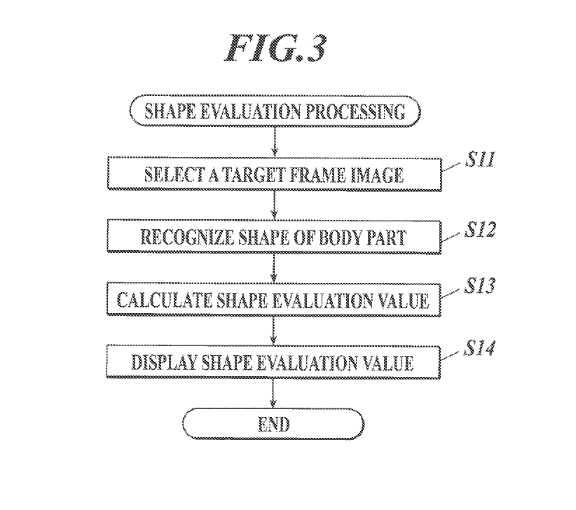

In the diagnostic console 3, when a series of frame images forming a dynamic image is received from the imaging console 2 via the communication section 35, the shape evaluation processing shown in FIG. 3 is executed in cooperation between the control section 31 and the program stored in the storage section 32.

Hereinafter, the flow of shape evaluation processing will be described with reference to FIG. 3.

First, a frame image (referred to as a target frame image) used for shape evaluation is selected from the plurality of frame images forming the dynamic image (step S11).

The target frame image may be selected automatically in cooperation between the control section 31 and the program or may be manually selected by a user.

In a case of automatically selecting the target frame image, the target frame image may be “selected on the basis of information obtained from the dynamic image” or may be “selected on the basis of biological information obtained by a separate sensor”.

In a case of “selecting the target frame image on the basis of information obtained from the dynamic image”, first, the temporal change in feature amount of a lung field which is the target site is obtained on the basis of the frame images forming the dynamic image. Then, the target frame image used for the shape evaluation is selected on the basis of the obtained temporal change in feature amount of the lung field. Filtering may be performed to the temporal change in feature amount of the lung field by a low-pass filter in a time axis direction in order to remove the noise.

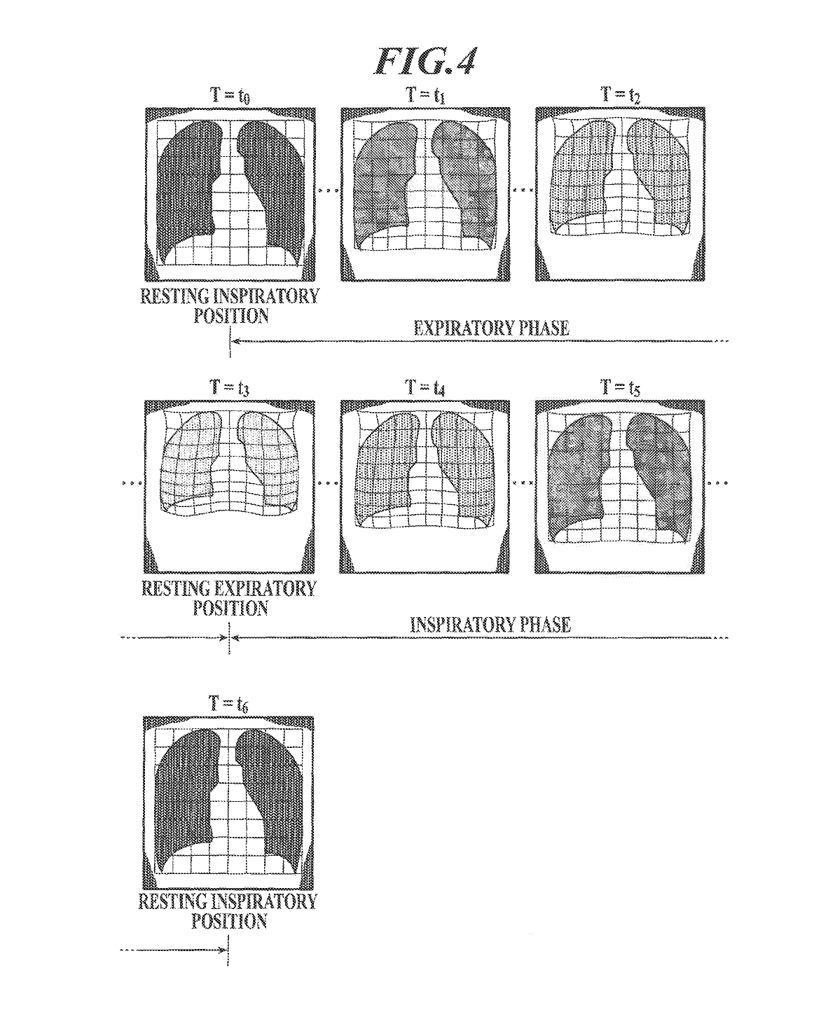

FIG. 4 shows frame images of a plurality of time phases T (T=t0 to t6) captured under the condition of quiet breathing. As shown in FIG. 4, the breathing cycle is formed of expiratory phase and inspiratory phase. During the expiratory phase, air is ejected from the lungs by raising the diaphragm and the region of the lung field is decreased as shown in FIG. 4. Thus, the concentration of lung field is increased and the lung field is drawn with lower density values (pixel values) in the dynamic image. The diaphragm is located highest at the resting expiratory position. During the inspiratory phase, air is taken into the lungs by lowering the diaphragm, and the region of lung field in the thorax is increased as shown in FIG. 4. Thus, the concentration of lung field is decreased and the lung field is drawn with higher density values in the dynamic image. The diaphragm is located lowest at the resting inspiratory position. In such way, the density of lung field, area of lung field and vertical position of diaphragm in each of the frame images of the chest dynamic image are feature amounts corresponding to the state of lung field at the imaging timing in the breathing movement, and the temporal changes of the feature amounts correspond to the change in lung field by the breathing movement.

In the embodiment, for example, the feature amount indicating the density (pixel values) in the lung field, the area of lung field or the vertical position of the diaphragm which moves in conjunction with the lung field is obtained from each of the frame images, and the target frame image to be used for the shape evaluation is selected on the basis of the temporal change which is obtained by arranging the obtained feature amounts in the time direction.

As the feature amount indicating the density of lung field, for example, the representative value (here, average value) of pixel values of the target region including at least a part of the lung field region can be applied. The target region is a region located at the same position (coordinate) in each of the frame images. The target region may be the entire image or may be a predetermined one point in the lung field region. The target region may be manually selected by a user or may be automatically selected by image processing. In a case of automatically selecting the target region by image processing, for example, a lung field region can be extracted from each of the frame images and the extracted lung field region is determined as the target region. The lung field region may be extracted by using any known method. For example, a threshold value is obtained by a discriminant analysis from histogram of pixel value for each pixel of the frame image, and the region having higher signals than the threshold value is primarily extracted as a lung field region candidate. Then, edge detection is performed around the border of the lung field region candidate which was primarily extracted, and the points having largest edges in small regions around the border are extracted along the border to extract the border of lung field region.

The feature amount indicating the area of lung field can be obtained by, for example, extracting the lung field region from each of the frame images and counting the number of pixels in the extracted lung field region.

As the feature amount indicating the vertical position of diaphragm, the distance in vertical direction (Y direction) between the lung apex and the diaphragm can be applied. As shown in FIG. 4, since the vertical position of lung apex is little influenced by the breathing movement and the position is little changed, the distance in the vertical direction between the lung apex and the diaphragm can represent the position of diaphragm in the vertical direction. Thus, for example, the position of lung apex is defined in advance to be the position located at the uppermost end in the lung field region, and the reference position of lung apex is specified by extracting the position located uppermost in vertical direction in the lung field region. Further, for example, the reference position of diaphragm is defined in advance to be the average position in the vertical direction of the curve of diaphragm, the curve of diaphragm is extracted from the lung field region (to be described in detail later), the average position in the vertical direction is obtained, and the obtained average position is specified as the reference position of diaphragm. By calculating the distance between the positions in vertical direction (Y coordinates) of the specified reference position of lung apex and the reference position of diaphragm, the feature amount indicating the vertical position of diaphragm can be calculated.

After the temporal change in feature amount of the lung field is calculated, the representative value (maximum value, minimum value, differential value, median value, average value or the like) of the feature amount of the lung field is calculated from the temporal change in feature amount, and the target frame image is selected by using the representative value.

For example, in a case of targeting the state when the lung field is momentarily still as the states at the resting expiratory position and at the resting inspiratory position in the breathing state, the frame image to be selected as the target frame image is a frame image corresponding to the point when the temporal change in feature amount of the lung field has the maximum value (local maximum value), minimum value (local minimum value), or the differential value being 0.

For example, in a case of targeting the state in which the lung field moves most, the frame image to be selected is a frame image corresponding to the point when the absolute value of differential value in the temporal change becomes a maximum.

The frame image to be selected may be a frame image corresponding to a median value or an average value of the temporal change. The frame image to be selected may be a frame image corresponding to a median value or an average value of differential values in the temporal change. The frame image to be selected may be a frame image which has a feature amount value of the lung field corresponding to a value equivalent to the n % (0<n<100) of the maximum value of the temporal change.

In a case where the target site moves for a cyclic movement as in the quiet breathing, phase information regarding phase in the cyclic movement of target site may be obtained from the dynamic image to select the target frame image on the basis of the phase information. For example, the information (such as resting expiratory position and resting inspiratory position) regarding the phase to be selected as the target frame image is set in advance, the phase (such as resting expiratory position and resting inspiratory position) in the cyclic movement of lung field in each of the frame images is recognized by obtaining the temporal change in the feature amount of lung field from the frame images forming the dynamic image and recognizing the local maximum value and local minimum value, and the frame image corresponding to the phase which was set to be selected as the target frame image may be automatically selected as the target frame image.

The method for selecting the frame image may be set from among the above methods in advance or may be set by a user via the operation section 33.

In a case of “selecting the frame image on the basis of biological information obtained by a separate sensor”, for example, when the dynamic image is captured, in synchronization with the dynamic imaging, the biological information is obtained by a separate sensor which obtains biological information corresponding to the dynamic state of the target site and is different from the imaging apparatus 1, and the frame image is selected by using the obtained biological information. As the separate sensor, there can be applied a respiration sensor which is a non-contact type or attached to the nose and detects the breathing of the subject being examined, for example. For example, the biological information obtained from the separate sensor is associated with each of the frame images, and the frame image corresponding to the target state (for example, the state in which breathing has stopped, breathe in most air, breathe out most air, or the like) of the biological information is selected as the target frame image, the target state being set in advance via the operation section 33 or the like.

In a case of manually selecting the frame image by a user, information related to the dynamic image is displayed as auxiliary information for selecting the frame image on the display section 34 in cooperation between the control section 31 and the program. The information related to the dynamic image includes each of the frame images forming the dynamic image or one-dimensional temporal change data of information obtained from each of the frame images, for example.

In a case of displaying each of the frame images, for example, the frame images are sequentially displayed (displayed as in the moving image) on the display section 34, and the frame image which was specified by user's operation to the operation section 33 from among the displayed frame images is selected as the target frame image. As shown in FIG. 5, thumbnail images of frame images may be displayed alongside on the display section 34, and the frame image specified by user's operation to the operation section 33 from among the displayed frame images (thumbnail images) may be selected as the target frame image.

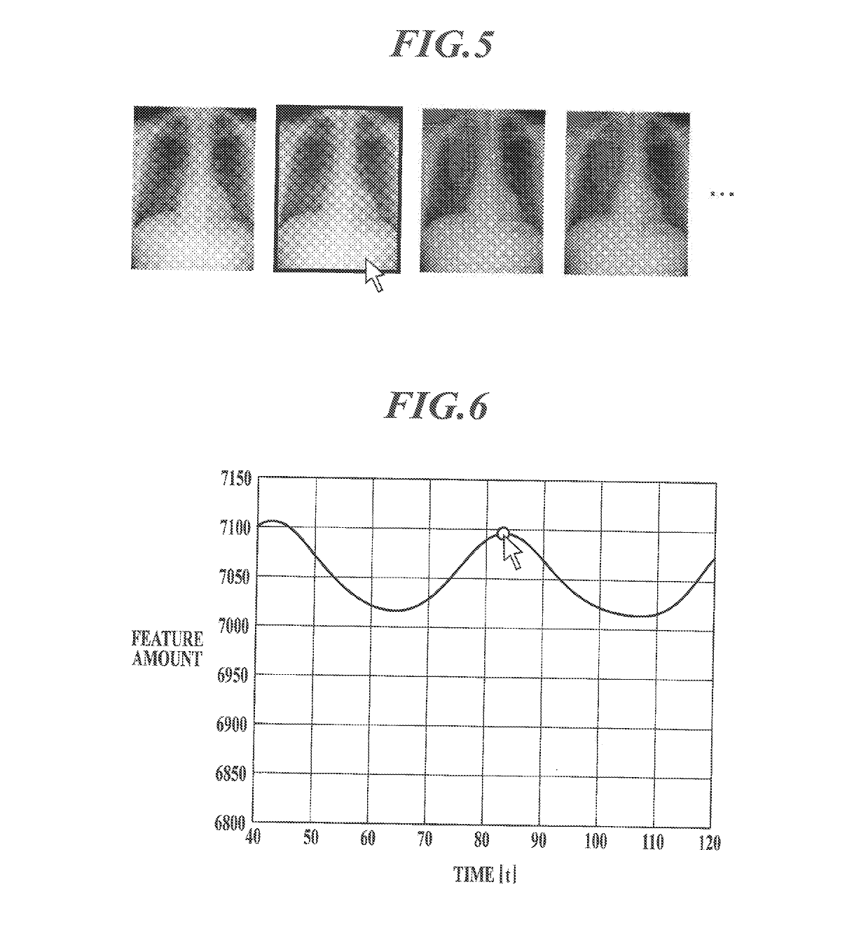

For example, a temporal change in the feature amount (above-mentioned density of lung field region, area of lung field region, vertical position of diaphragm or the like) of the target site may be obtained from a plurality of frame images forming the dynamic image, a graph (see FIG. 6) showing the obtained temporal change may be displayed on the display section 34, and the frame image corresponding to the position on the graph specified by user's operation to the operation section 33 may be selected as the target frame image.

In a case where the target site moves for a cyclic movement as in the quiet breathing, for example, there is a plurality of points where the differential value is 0 and a plurality of frame images at the resting expiratory position and the resting inspiratory position. In this case, a plurality of frame images may be selected.

When the selection of target frame image is finished, the shape of the body part which is the target of shape evaluation is recognized from the selected target frame image (step S12). Though the following description takes, as an example, a case where the body part which is the target of shape evaluation is the diaphragm (right diaphragm), the body part may be the heart or the thorax.

For example, as the processing of recognizing the right diaphragm from the target frame image, the edges of lung field including the diaphragm are first extracted by performing the known edge extraction processing (such as Sobel filter processing and Prewitt filter processing) to the target frame image. Next, setting the upper left of the target frame image to be the origin, the right direction to X direction (+X direction) and the downward direction to Y direction (+Y direction), each X coordinate is searched from +Y side to −Y side for an edge among the edges extracted from the target frame image, the edge being located within the region of left half of the target frame image and extending along, to some degree, the X axis which is nearly orthogonal to the movement direction of the diaphragm. The curve which is a set of the edges (points) first detected for respective X coordinates and the points continuous with the detected edges is extracted as the shape of right diaphragm.

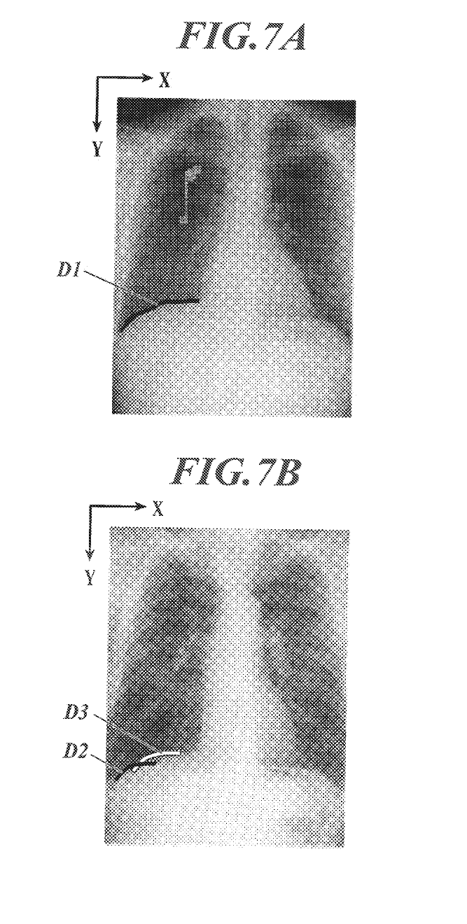

Here, in the image obtained by capturing the chest from front side, the shape of diaphragm for a healthy person is drawn as a single continuous curve as indicated by the thick line D1 in FIG. 7A. On the other hand, as indicated by thick lines D2 and D3 in FIG. 7B, the diaphragm for a patient having a disease in lung, is compressed by the lung, and the shape of diaphragm is drawn as the shape having a plurality of curves which are connected to each other, that is, the shape having a plurality of undulations in some cases. FIG. 7B illustrates the shape of right diaphragm having two curves D2 and D3 connected to each other, that is, having two undulations.

For example, the target frame image may be displayed on the display section 34, and the shape which was specified (for example, traced) on the displayed target frame image by user's operation to the operation section 33 may be recognized as the shape of right diaphragm.

When the shape recognition of body part is finished, the evaluation value for evaluating the recognized shape of body part is calculated (step S13).

When the chest is seen from the front side, the normal diaphragm not having a disease in lung is curved, whereas the diaphragm having a severer disease in lung is closer to the linear shape. When the chest is seen from the front side, the normal diaphragm not having a disease in lung has a single continuous curve as indicated by D1 in FIG. 7A, whereas the diaphragm of severe COPD patient has undulations and has the shape connecting a plurality of curves as indicated by D2 and D3 in FIG. 7B.

Thus, in step S13, for example, an index value indicating linearity of the shape of body part, an index value indicating curvedness, an inclination and/or the number of undulations is calculated as the evaluation value of the shape of body part.

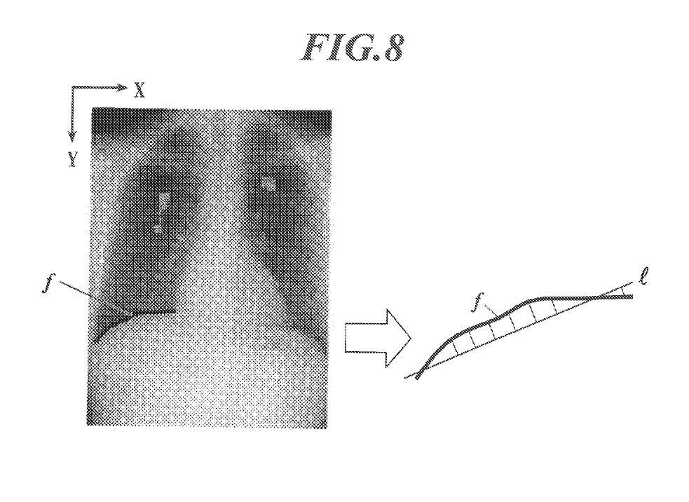

The index value indicating linearity is a value indicating closeness of the shape of body part to a straight line. For example, as shown in FIG. 8, the approximate line 1 of the shape f recognized in step S12 is calculated by using the method of least squares or the like, and the maximum value or the average value of the shift amounts (distances) between the calculated approximate line and the extracted shape can be the index value indicating linearity. The index value indicating linearity in this case is smaller as the shape is closer to the straight line, and the possibility of lung abnormality is larger.

The index value indicating curvedness is a value indicating the degree of curve of the shape of body part. For example, the curvature of the shape recognized in step S12 can be calculated and the calculated curvature can be the index value indicating curvedness. As the curvature is smaller, the possibility of lung abnormality is larger.

The approximate curve of the shape extracted in step S12 may be calculated by using the method of least squares or the like, and the coefficient of function representing the calculated approximate curve may be the index value indicating curvedness. For example, the shape extracted in step S12 may be approximated by a quadratic function and the coefficient of squared term may be the index value indicating curvedness. As the absolute value of the coefficient is smaller, the possibility of lung abnormality is larger.

The inclination is a value indicating the degree of inclination of the body part. For example, the approximate straight line of the shape recognized in step S12 may be calculated by using the method of least squares or the like and the coefficient of function representing the calculated approximate straight line can be the inclination.

The number of undulations can be calculated by counting the number of curves forming the shape recognized in step S12. The number of local values (local maximums) of the shape recognized in step S12 may be calculated to be the number of undulations.

As the shape evaluation value, either one or more of the index value indicating linearity of the shape of body part, the index value indicating curvedness, the inclination and the number of undulations may be calculated. In a case where a plurality of target frame images is selected in step S11, the shape evaluation value is calculated from each of the selected plurality of target frame images, the representative value of the calculated plurality of shape evaluation values such as average value, median value, maximum value and minimum value is calculated to be the shape evaluation value.

When the calculation of shape evaluation value is finished, the calculated shape evaluation value is displayed on the display section 34 (step S14), and the shape evaluation processing ends.

As described above, according to the diagnostic console 3, the control section 31 selects one or more target frame images from among a plurality of frame images obtained by dynamic imaging of the target site in the living body, recognizes the shape of a predetermined body part from the selected target frame image(s) and calculates the evaluation value of the recognized shape of body part.

Accordingly, since the evaluation value of the shape of body part which was recognized from each of the target frame image(s) selected from the dynamic image can be provided for a doctor to diagnose the target site, it is possible to suppress the amount of information to be provided to the doctor compared to the conventional diagnosis from dynamic image, and suppress the burdens on doctors at diagnosis and the difference in diagnosis result according to the proficiencies of doctors. That is, it is possible to perform efficient and stable diagnosis based on the shape of body part included in the dynamic image.

For example, the control section 31 automatically selects the target frame image (s) on the basis of information obtained from a plurality of frame images forming the dynamic image. Specifically, the control section 31 obtains temporal change in feature amount of the target site (for example, for each of the plurality of frame images, pixel values in a predetermined region including at least part of the target site, the area of target site or the positional information of a body part which moves in conjunction with the target site), and automatically selects the target frame image (s) on the basis of the obtained temporal change in the feature amount. Accordingly, it is possible to save the user from selecting the target frame image (s) to be used for shape evaluation from among the captured frame images, and thus the diagnosis can be performed efficiently and stably.

The frame image (s) may be automatically selected on the basis of biological information obtained from a sensor which obtains biological information corresponding to the dynamic state of target site in synchronization with the dynamic imaging. Thereby, it is possible to save the user from selecting the target frame image (s) to be used for shape evaluation from among a plurality of frame images forming the dynamic image, and thus, diagnosis can be performed efficiently and stably.

The information related to the dynamic image is displayed on the display section 34, and the target frame image(s) is selected according to user's operation to the displayed information related to the dynamic image.

For example, by displaying a plurality of frame images forming the dynamic image on the display section 34 and selecting, as the target frame image(s), the frame image(s) specified by user's operation from among the displayed plurality of frame images, the user can easily select the desired frame image(s) as the target frame image(s).

For example, by displaying a graph showing the temporal change in feature amount of the target site obtained from a plurality of frame images forming the dynamic image on the display section 34 and selecting the target frame image(s) on the basis of the position specified by user's operation on the displayed graph, it is possible to easily select the frame image(s) desired by the user as the target frame image(s).

The control section 31 calculates, as the evaluation value, the index value indicating linearity of the recognized shape of the body part, the index value indicating curvedness, the inclination of the body part and/or the number of undulations in the body part. Accordingly, since the shape evaluation value for quantitatively determining whether the target site is abnormal can be provided to the doctor, the doctor can perform the diagnosis efficiently and stably.

The description in the embodiment is an example of a preferred dynamic analysis system according to the present invention, and the present invention is not limited to this.

For example, the embodiment has been described for an example of using a hard disk or a semiconductor non-volatile memory and such like as a computer readable medium of program according to the present invention. However, the present invention is not limited to this example. A portable recording medium such as a CD-ROM can be applied as other computer readable medium. A carrier wave is also applied as the medium for providing program data according to the present invention via a communication line.

As for the other detailed configurations and detailed operations of apparatuses forming the dynamic analysis system 100, modifications can be appropriately made within the scope of the present invention.

What is claimed is:

1. A dynamic analysis apparatus, comprising a processor which selects one or more frame images from a plurality of frame images of a dynamic image that is obtained by performing radiation imaging of a subject including a target site in a living body, recognizes a shape of a predetermined body part from each of the selected one or more frame images and calculates an evaluation value of the recognized shape of the body part.

2. The dynamic analysis apparatus according to claim 1, wherein the processor selects the one or more frame images on the basis of information obtained from the plurality of frame images.

3. The dynamic analysis apparatus according to claim 2, wherein the processor obtains a temporal change in a feature amount of the target site from the plurality of frame images and selects the one or more frame images on the basis of the temporal change in the feature amount of the target site.

4. The dynamic analysis apparatus according to claim 3, wherein the processor obtains a representative value of the temporal change in the feature amount of the target site and selects the one or more frame images on the basis of the obtained representative value.

5. The dynamic analysis apparatus according to claim 3, wherein the processor obtains information regarding a phase in a cyclic movement of the target site on the basis of the temporal change in the feature amount of the target site and selects the one or more frame images on the basis of the obtained information regarding the phase.

6. The dynamic analysis apparatus according to claim 3, wherein the feature amount of the target site is a pixel value within a predetermined region including at least part of the target site, an area of the target site or positional information of a body part which moves in conjunction with the target site in each of the plurality of frame images.

7. The dynamic analysis apparatus according to claim 1, wherein the processor selects the one or more frame images on the basis of biological information obtained from a sensor which obtains biological information corresponding to a dynamic state of the target site in synchronization with dynamic imaging.

8. The dynamic analysis apparatus according to claim 1, further comprising a display section on which information related to the dynamic image is displayed, wherein
the processor selects the one or more frame images on the basis of user's operation to the information related to the dynamic image displayed on the display section.

9. The dynamic analysis apparatus according to claim 8, wherein
the plurality of frame images is displayed on the display section, and
the processor selects one or more frame images specified by user's operation from among the plurality of frame images displayed on the display section.

10. The dynamic analysis apparatus according to claim 8, wherein
information indicating a temporal change in a feature amount of the target site obtained from the plurality of frame images is displayed on the display section, and
the processor selects the one or more frame images on the basis of user's operation to the information which is displayed on the display section and indicates the temporal change in the feature amount of the target site.

11. The dynamic analysis apparatus according to claim 1, wherein the processor calculates, as the evaluation value, an index value indicating linearity of the recognized shape of the body part.

12. The dynamic analysis apparatus according to claim 1, wherein the processor calculates, as the evaluation value, an index value indicating curvedness of the recognized shape of the body part.

13. The dynamic analysis apparatus according to claim 1, wherein the processor calculates, as the evaluation value, an inclination of the recognized shape of the body part.

14. The dynamic analysis apparatus according to claim 1, wherein
the body part recognized by the processor is a diaphragm, and
the processor calculates a number of undulations in the recognized body part as the evaluation value.

15. A dynamic analysis system, comprising:
a radiation imaging apparatus which obtains a plurality of frame images of a dynamic image by performing radiation imaging of a subject including a target site in a living body; and
a diagnostic console which includes a processor that selects one or more frame images from the plurality of frame images of the dynamic image obtained by the radiation imaging apparatus, recognizes a shape of a predetermined body part from each of the selected one or more frame images and calculates an evaluation value of the recognized shape of the body part.
